(19) United States
(12) Patent Application Publication
(10) Pub. No.: US 2026/0268026 A1
(43) Pub. Date: Sep. 10, 2026

(54) Data Storage Device with Cryptographic Operation

(71) Applicant: Sandisk Technologies, Inc., Milpitas, CA (US)

(72) Inventors: Ran Zamir, Ramat Gan (IL); Dganit Levi, Burgata (IL); Idan Goldenberg, Ramat Hasharon (IL); Danny Berler, Tel Mond (IL); Eran Sharon, Rishon-Lezion (IL)

(73) Assignee: Sandisk Technologies, Inc., Milpitas, CA (US)

(21) Appl. No.: 19/072,680

(22) Filed: Mar. 6, 2025

(51) Int. Cl. G06F 21/72; G06F 9/30; G06F 21/79

(52) U.S. Cl. CPC G06F 21/72; G06F 9/30065; G06F 21/79

(57) ABSTRACT

A data storage device (DSD) includes a storage medium configured to store user data, a controller, and a cryptography module (CM) including one or more hashing components and one or more auxiliary components. The controller controls the CM to generate cryptographic output data for performing cryptographic operations on the user data. The CM is an integrated hardware element that receives input data representing a cryptographic seed value. The CM generates, using the one or more hashing components, hashing data representing a result of hashing the input data. The CM generates, using the one or more auxiliary components, auxiliary data representing a result of performing one or more auxiliary operations using the hashing data.

### TECHNICAL FIELD

This disclosure relates to devices, methods and systems for conducting one or more cryptographic operations of a data storage device (DSD), and in particular for generating a cryptographic output, such as a set of pseudorandom coefficients or a cryptographic key, that can be used to secure user data stored on the DSD by performing any of the cryptographic operations.

### BACKGROUND

Data storage devices (DSDs) are electronic devices with the capability to store information in the form of digital data. DSDs are typically deployed as an integrated part of, or as a removable component configured to interface with, a computing system for the purpose of improving the data transmission and storage capabilities of the system. From the perspective of the computing system, a DSD is typically implemented as a block storage device where the data stored is in the form of one or more blocks, being sequences of bytes or bits having a maximum length, referred to as block size.

DSDs are commonly used to supplement the data storage capabilities of a computer system. For example, external DSDs are often standalone physical devices which house an internal storage component, such as a hard disk drive (HDD) or a solid state drive (SSD), that provides a host computing system with an additional portion of non-volatile memory (i.e., the volume of the drive) in which to store digital data. These external drive type devices are connectable to the host computer system via a data path operating over a particular connectivity protocol (e.g., via Universal Serial Bus (USB) cable). In response to being connected to the host computer system, the host computer system recognizes the drive as a block data storage device such that a user of the device may access the storage of the drive via the data path (e.g., through operation of the host computer). Access to the drive typically enables a user to access (e.g., read, write and/or modify) user data content stored on the drive.

Some DSDs are configured for use in environments where there is a need to protect the data stored on the internal storage component. For example, if the data stored within a DSD is unprotected then it may be vulnerable to access by an unauthorized user resulting in the exposure of any associated sensitive information. An attacker may perform malicious activities on the DSD in an attempt to gain access to the stored data, including executing processes on the host computing system, often without user knowledge (termed “malware”), or on the DSD itself, such as within the internal memory of the device controller. In some cases, the attacker may attempt to read stored data from the DSD by accessing the storage component in an unauthorized manner (e.g., by physically compromising the device).

Cryptographic operations provide a means for securing digital data. For example, encryption transforms readable data (plaintext) into an unreadable format (ciphertext) using cryptographic keys, while decryption reverses this process, making the data accessible only to authorized users. Cryptographic operations such as encryption and decryption may be performed by a control component of the DSD to ensure that data stored within the DSD remains confidential, even if an unauthorized user obtains physical access to the storage component.

Quantum computing poses a threat to the security provided by conventional cryptography techniques used with DSDs. Quantum computers have the potential to break many of the cryptographic algorithms currently in use, such as the Rivest Shamir Adleman (RSA) and elliptic curve cryptography (ECC) algorithms, by efficiently solving problems that are computationally infeasible for classical computers. This has significant implications for the utility of DSDs, and particularly for their ability to provide secure long-term storage of data. For example, DSDs are commonly used to archive vast amounts of sensitive data (e.g., healthcare records and financial information) that may need to be secured for decades, thereby outlasting the projected timeline for the obsolescence of current cryptographic standards.

To address this threat, recent research has focused on developing cryptographic algorithms that are resistant to quantum attacks, also referred to as “post-quantum cryptography” (PQC). PQC techniques have potential to provide long-term security for DSDs, ensuring that encrypted data remains secure when stored on the device even in response to continued advancements in quantum computation.

An example of a PQC technique is lattice-based cryptography. This technique is based on a lattice structure which is created by integer linear combinations of basis vectors (i.e., forming a regular structure in an n dimensional space). Alternatively, or additionally, a lattice can be perceived as an arrangement of points in a Euclidean space with a regular structure. The difficulty of breaking a lattice-based cryptography system is related to the difficulty of solving mathematical problems in the lattice, such as the Shortest Vector Problem (SVP) and the Learning With Errors (LWE) problem, which are extremely computationally complex.

Various algorithms for module-lattice-based cryptography have been proposed by the National Institution for Standards and Technology (NIST), including the FIPS 203 ML-KEM, based on the CRYSTALS-Kyber algorithm, for key exchange and key de/encapsulation operations (see [1]), and the FIPS 204 ML-DSA, based on the CRYSTALS-Dilithium algorithm for digital signature, signature verification and key generation operations (see [2]).

In another example, password-based key derivation functions (PBKDFs) may be used to derive cryptographic keys from passwords or passphrases provided by a user of the DSD, such as to protect electronic data or data protection keys stored on the DSD. Exemplary algorithms for PBKDF cryptography have been proposed by NIST (see [3]). PBKDF cryptography techniques can be made increasingly quantum-resistant by adjusting the algorithm parameters, such as, for example, the iteration count over which the secure key is derived.

### SUMMARY

Disclosed herein is a data storage device comprising: a non-volatile storage medium configured to store user data; a data port configured to transmit data between a host computer system and the data storage device via a data path; a cryptography module comprising: one or more hashing components; and one or more auxiliary components; and a controller configured to control the cryptography module via a local bus to generate cryptographic output data for performing one or more cryptographic operations on the user data, wherein the cryptography module is implemented as an integrated hardware element configured to: receive, from the local bus, input data representing at least a cryptographic seed value; generate, using the one or more hashing components, hashing data representing a result of performing a hashing operation on the input data; provide the hashing data to the one or more auxiliary components; and generate, using the one or more auxiliary components, auxiliary data representing a result of performing one or more auxiliary operations using the hashing data.

In some embodiments, the cryptography module is configured to selectively transition between operating in: a first mode in which the cryptography module generates the cryptographic output data as the auxiliary data; and a second mode in which the cryptography module generates the cryptographic output data as the hashing data.

In some embodiments, the cryptography module comprises one or more of: an input buffer configured to: receive the input data from an interface to the local bus; and provide at least the input data to the one or more hashing components; an intermediate data buffer configured to: receive the hashing data from the one or more hashing components; store the hashing data; and provide the hashing data to the one or more auxiliary components; and an output buffer configured to: receive the hashing data when the cryptography module is operated in the second mode; receive the auxiliary data when the cryptography module is operated in the first mode; and provide the hashing data or the cryptographic output data to the interface.

In some embodiments, the one or more auxiliary components comprises a sampler unit configured to generate the auxiliary data as a set of pseudorandom coefficients by mapping the set of pseudorandom bits to a sampling distribution of a sampling function, the one or more hashing components comprises a hashing calculation unit, and the device further comprises the intermediate data buffer connected to the hashing calculation unit and the sampler unit, wherein the intermediate data buffer is configured to: read the hashing data from the hashing calculation unit, wherein the hashing data comprises a set of pseudorandom bits representing an expansion of the cryptographic seed value using a hashing function or an extendable-output function; store the hashing data; and transmit the hashing data to the sampler unit.

In some embodiments, the intermediate data buffer is configured to provide one or more control signals to the hashing calculation unit to indicate a state of the data buffer.

In some embodiments, the cryptography module is further configured to: (i) determine whether a rate of generation of the hashing data exceeds a rate of generation of the pseudorandom coefficients by at least a predetermined threshold value; and (ii) in response to a positive determination in step (i), perform a masking of the hashing operation.

In some embodiments, the masking the hashing operation comprises one or more of: performing one or more redundant calculations associated with the hashing operation during one or more clock cycles; and completing a calculation of the hashing operation by performing each of a plurality of parts of the calculation over a respective plurality of clock cycles.

In some embodiments, the sampling distribution is one of: a uniform distribution; a distribution representing a polynomial in a NTT domain; and a centred binomial distribution.

In some embodiments, the one or more auxiliary components comprises an XOR unit, the cryptographic seed value of the input data comprises a user password value; and the hashing calculation unit and the XOR unit perform respective operations to generate the hashing data and the auxiliary data over a predetermined plurality of iterations, to generate the auxiliary data representing at least part of a secure cryptographic key.

In some embodiments, the XOR unit is configured to, during a current iteration: receive the hashing data generated by the hashing calculation unit, wherein the hashing data comprises a set of pseudorandom bits representing an expansion of at least one of: a value represented by hashing data of a previous iteration; and the cryptographic seed value; receive auxiliary data of the previous iteration from the output buffer; and perform a bitwise exclusive-or operation on the received hashing data, and the auxiliary data of the previous iteration, to generate the auxiliary data of the current iteration as a set of candidate bits.

In some embodiments, the input buffer is further configured to: receive, during the current iteration, the hashing data generated the hashing calculation unit, and provide, to the hashing calculation unit during the current iteration, the hashing data of the previous iteration.

In some embodiments, the one or more cryptographic operations are Lattice-based cryptographic operations.

Disclosed herein is an integrated hardware cryptography module to generate a cryptographic output for performing one or more cryptographic operations of a data storage device, the method comprising: receiving, from a local bus of the data storage device, input data representing at least a cryptographic seed value; generating, by a hashing calculation unit of the cryptography module, hashing data representing a result of performing a hashing operation on the input data; providing the hashing data to an auxiliary unit of the cryptography module; and generating, by the auxiliary unit of the cryptography module, cryptographic output data representing a result of performing one or more auxiliary operations using the hashing data.

In some embodiments, the auxiliary unit is a sampler unit configured to implement a sampling function, and the method further comprising: receiving the input data by the hashing calculation unit; operating the hashing calculation unit on the input data to generate the hashing data as a set of pseudorandom bits representing an expansion of the cryptographic seed value using a hashing function or an extendable-output function; providing the hashing data to the sampler unit; and operating the sampler unit on the hashing data to generate a set of pseudorandom coefficients by mapping the set of pseudorandom bits to a sampling distribution of the sampling function.

In some embodiments, the method further comprises: (i) determining whether a rate of generation of the hashing data exceeds a rate of generation of the pseudorandom coefficients by at least a predetermined threshold value; and (ii) in response to a positive determination in step (i), performing a masking of the hashing operation.

In some embodiments, the masking of the hashing operation comprises one or more of: performing one or more redundant calculations associated with the hashing operation during one or more clock cycles; and completing a calculation of the hashing operation by performing each of a plurality of parts of the calculation over a respective plurality of clock cycles.

In some embodiments, the cryptographic seed value of the input data comprises a user password value, wherein the auxiliary unit is an XOR unit, and wherein the method further comprises, in a current iteration of processing: (i) receiving, by the hashing calculation unit, data including at least one of: the input data; and stored hashing data of a previous iteration; (ii) operating the hashing calculation unit on the data to generate the hashing data comprising a set of pseudorandom bits representing an expansion of at least one of: a value represented by the hashing data of the previous iteration; and the cryptographic seed value of the input data; (iii) storing the hashing data generated in step in at least one data buffer of the cryptography module; (iv) receiving, at the XOR unit, the hashing data generated in step and stored auxiliary data of the previous iteration; and (v) operating the XOR unit to perform a bitwise exclusive-or operation on the received hashing data, and the auxiliary data of the previous iteration, to generate auxiliary data of the current iteration representing a candidate set of bits.

In some embodiments, steps (i) to (v) are performed over a predetermined plurality of iterations, to generate at least part of a secure cryptographic key from the candidate set of bits represented by auxiliary data of a final iteration of the steps (i) to (v).

In some embodiments, the method further comprises: storing the hashing data generated in step in an input buffer of the cryptography module, wherein the input buffer is configured to receive the input data from an interface to the local bus; and receiving, by the hashing calculation unit from the input buffer, the input data and the stored hashing data of the previous iteration.

Disclosed herein is a cryptographic system of a data storage device, the cryptographic system comprising: means for generating a cryptographic seed value; means for using a pseudorandom number output associated with the cryptographic seed value to perform the one or more cryptographic operations on user data stored by the data storage device; and means for controlling an integrated hardware cryptography module of the cryptographic system to the generate pseudorandom number output associated with the cryptographic seed value by using: means for receiving, by the integrated cryptography module, input data representing the cryptographic seed value; means for generating, by one or more hashing components of the integrated cryptography module, hashing data representing a result of performing a hashing operation on the cryptographic seed value; means for providing the hashing data to one or more auxiliary components of the cryptography module; and means for generating, by the one or more auxiliary components of the integrated cryptography module, auxiliary data representing a result of performing one or more auxiliary operations on at least the hashing data.

### BRIEF DESCRIPTION OF DRAWINGS

Some embodiments are described herein below with reference to the accompanying drawings, wherein:

FIG. 1a is a block diagram of a first example of a conventional cryptography system;

FIG. 1b is a block diagram of a second example of a conventional cryptography system;

FIG. 1c is a flow diagram of an algorithm for performing password-based key derivation (PBKD) with a cryptography system;

FIG. 2a is a block diagram of a cryptography system including an integrated cryptography module, according to some embodiments of the proposed technology;

FIG. 2b is a block diagram of an example data storage device (DSD) including the cryptography system of FIG. 2a, according to some embodiments of the proposed technology;

FIG. 2c is a block diagram of an example of the cryptography system of FIG. 2a implemented as a hardware security module (HSM) in a DSD, according to some embodiments of the proposed technology;

FIG. 3 is a flow diagram of a method for using a cryptography module of the HSM of FIG. 2c to generate a cryptographic output for performing one or more cryptographic operations on a DSD, according to some embodiments of the proposed technology;

FIG. 4 is a block diagram of a first implementation the cryptography module of the HSM of FIG. 2c, according to some embodiments of the proposed technology;

FIG. 5a is a flow diagram of a method for using the cryptography module of FIG. 4 to generate a set of pseudorandom bits for use by a cryptographic system, according to some embodiments of the proposed technology;

FIG. 5b is a flow diagram of a data flow of a sampling process performed by a sampler unit of the cryptography module of FIG. 4 performing the method of FIG. 5a;

FIG. 6 is a block diagram of a second implementation the cryptography module of the HSM of FIG. 2c, according to some embodiments of the proposed technology;

FIG. 7 is a flow diagram of a method for using the cryptography module of FIG. 6 to generate a set of pseudorandom bits for deriving a cryptographic key using a cryptographic system, according to some embodiments of the proposed technology; and

FIG. 8 is a flow diagram of a method performed by a cryptography controller to control the HSM of FIG. 2c to generate cryptographic output data for performing a cryptographic operation on user data of the DSD, according to some embodiments of the proposed technology.

### DESCRIPTION OF EMBODIMENTS

### Challenges of Quantum-Resistant Cryptography on a Data Storage Device

There are technical challenges associated with implementing quantum-resistant cryptographic operations cryptographic operations on a DSD. For example, lattice-based cryptography requires the generation of a large number of random coefficients in order to introduce small random errors (i.e., noise) into the cryptographic operations. The presence of the random errors makes it difficult for an attacker to distinguish between valid and invalid ciphertexts or to solve the underlying lattice problems. PBKDFs also require the repeated generation of pseudorandom outputs over a large number of iterations, for example in order to convert a user password value into a cryptographic key that is sufficiently secure against a quantum computation-based attack.

In general, the ability to conduct quantum-resistant cryptographic operations on a DSD, for example using lattice-based or PBKD techniques, is dependent on an ability to drive the underlying algorithms with a source of cryptographic material that has a high degree of entropy (e.g., pseudorandom bit and/or byte sequences). This provides a high degree of randomness in the generated cryptographic keys, thereby strengthening the implementation of the associated encryption and decryption operations against computation-based attacks.

The generation of a large number of truly random numbers is often infeasible to achieve using the computational power available to most small scale devices such as DSDs. Instead, cryptography systems implemented in such devices (also known as “cryptographic engines”) typically generate (or receive) a relatively smaller truly random value which is used as a cryptographic seed to generate a set of pseudorandom values, which are in turn output (i.e., as a “cryptographic output”) as the source material for performing operations such as key exchange, key decapsulation or encapsulation, and/or key generation. For example, one or more hashing operations may be performed to expand a random cryptographic seed value, and one or more other operations (referred to herein as “auxiliary operations”) are then performed to generate the cryptographic output, such as a set of larger pseudorandom numbers or a cryptographic key.

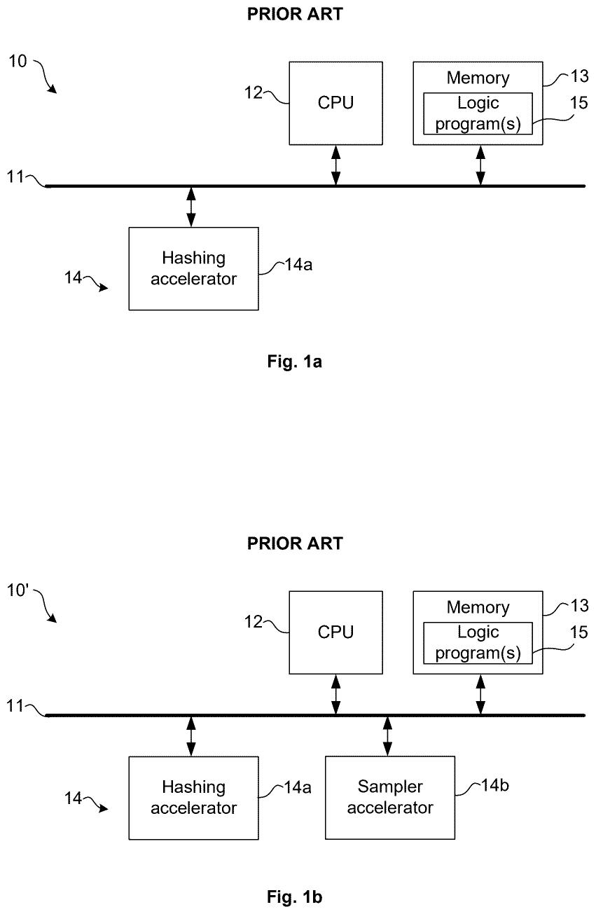

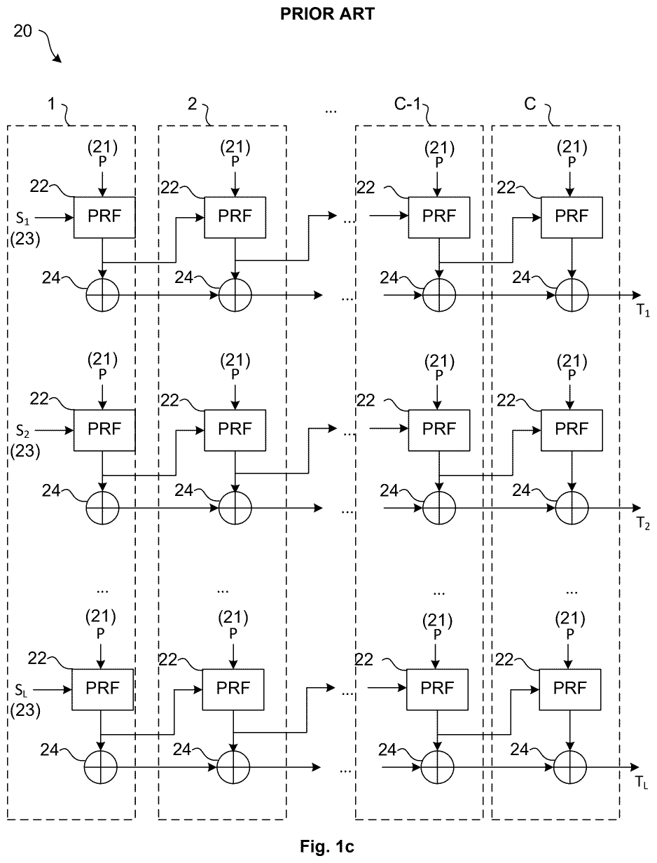

FIG. 1a illustrates a first example of a conventional cryptography system 10 for implementation in a DSD. Cryptography system 10 comprises a local bus 11 providing communication between system components including at least one processor (CPU) 12, a memory system 13, and one or more accelerator modules 14. One or more accelerator modules 14 provide a hardware capability to perform one or more functions associated with the cryptographic operations. For example, the one or more accelerator modules 14 includes a hashing accelerator 14a configured to accelerate the execution of one or more hashing functions such as the SHA-3 hash, and optionally one or more extendable-output (XOF) functions such as SHAKE. The memory system 13 is configured to provide one or more logic programs 15, for example as firmware, for execution by the CPU 12. The logic program(s) 15 are configured to perform particular functions according to the cryptographic operations implemented by the cryptography system 10.

For example, to conduct lattice-based cryptographic operations according to FIPS 203 ML-KEM and FIPS 204 ML-DSA using the system 10 shown in FIG. 1a, the logic program(s) 15 implement a sampler function which generates a set of pseudorandom coefficients with a desired distribution by shaping a set of pseudorandom bits having a known (e.g. uniform) distribution that are input into the sampler function. The hashing accelerator 14a generates pseudorandom bit data 3 from the cryptographic seed 1 received from the CPU 12, and transmits the pseudorandom bit data 3 back to the CPU 12. The CPU 12 invokes the logic program(s) 15 on pseudorandom bit data 3 received from the hashing accelerator 14a, via the local bus 11, to generate the pseudorandom coefficients as cryptographic output 5. The disadvantage of this approach is the reliance on the CPU 12 to execute sampling calculations which degrades the performance of the lattice-based cryptographic operations. Further, data is passed between the hashing accelerator 14a and the CPU 12 to enable the sampler function to generate the cryptographic output 5 from the pseudorandom bits 3.

FIG. 1b illustrates an alternative conventional cryptography system 10′ comprising a hashing accelerator 14a and a logic accelerator 14b. The logic accelerator 14b comprises dedicated hardware components configured to perform the auxiliary functions, thereby enabling the system 10′ to execute at least part of the auxiliary functions without directly using the CPU 12.

For example, to conduct lattice-based cryptographic operations according to FIPS 203 ML-KEM and FIPS 204 ML-DSA using the system 10′ shown in FIG. 1b, logic accelerator 14b may be configured as a dedicated sampler accelerator 14b configured to implement the sampler function. The hashing accelerator 14a generates pseudorandom bit data 3 from the cryptographic seed 1 and transmits the pseudorandom bit data 3 to the sampler function implemented by the sampler accelerator 14b using the local bus 11. The sampler accelerator 14b shapes the pseudorandom bits according to the sampler function, and then passes the generated cryptographic output 5 to the CPU 12 and/or memory 13.

The disadvantage of this approach is that it requires two dedicated hardware modules 14a and 14b that are implemented separately and that each access the local bus 11 via corresponding ports. This increases the area of the embedded chip supporting the cryptography system 10′ and its power consumption. Further, the local bus 11 is required to support communication between the separate and independently controlled accelerators 14a and 14b and the CPU 12 and/or memory 13, thereby increasing the data bandwidth requirements of the local bus 11 and the complexity/overheads associated with executing the cryptography system 10′.

Similar challenges also exist for implementing PBKD-based cryptographic operations. FIG. 1c illustrates an algorithm 20 for performing PBKD with a cryptography system. With reference to FIGS. 1a and 1b, to perform algorithm 20 each of cryptography systems 10 and 10′ may implement a Pseudorandom Function (PRF) 22 as a hashing operation using the hashing accelerator 14a, where the PRF 22 is executed iteratively over a fixed number of iterations 1,2, . . . , C. For an initial iteration 1, the PRF 22 is executed on input data representing values of a user defined password (P) 21, and a salt (Sj) 23 which is implemented as a set of random bits. In such implementations, the auxiliary operations involve: the execution of bit-wise exclusive OR (“XOR”) functions 24 performed between the result of the PRF and the result of XOR in the previous iteration; the transfer of the data from the output of the PRF to the XOR; storage of the XOR result; and copying of the PRF output data to the associated input. After C iterations of processing, the algorithm 20 outputs a block Tj as a set of bits for a given input password P and salt value Sj, where the set of blocks T₁, T₂, . . . , T_{L}, may be combined to produce a secure cryptographic key mk (e.g., by concatenation as described in reference [3]).

To achieve improved resistance to quantum-based attacks, the iteration count may be set to C=10,000 or even higher. However, this also leads to an increase in the computational requirements for conducting PBKD. In particular, the PRF (hashing) 22 and XOR 24 operations must be computed serially for each block of the derived key (labelled Tⱼ), as the input for each hashing operation depends on the result of the previous hashing operation. Therefore, using the conventional architectures of cryptography systems 10 and 10′ has a disadvantage in that, regardless of whether the XOR functions 24 are performed in firmware on the CPU 12, as for system 10 shown in FIG. 1a (or in a dedicated logic accelerator 14b, as for system 10′ shown in FIG. 1b), a large amount of data is frequently transferred between the hashing accelerator 14a and the CPU 12 (or the logic accelerator 14b). This results in similar technical drawbacks as described above for the generation of pseudorandom coefficients—i.e., inefficiencies in cryptography system chip layout, power consumption, and computational performance (e.g., due to data transfer and control overheads associated with use of the local bus 11).

The problems outlined above in the context of the lattice-based and PBKD cryptography algorithms also exist when securing data using other cryptography algorithms. That is, conventional cryptography systems that generate a cryptographic output (e.g., a set of pseudorandom values) using at least one hardware accelerator module are limited in that they require embedded circuitry with a large chip area, and/or provide reduced performance, in conducting cryptographic operations that are quantum-resistant. It is therefore desired to provide devices, methods, and systems that ameliorate one or more of these difficulties, or other difficulties of the prior art, or that at least provides a useful alternative.

### Overview of the Proposed Technology

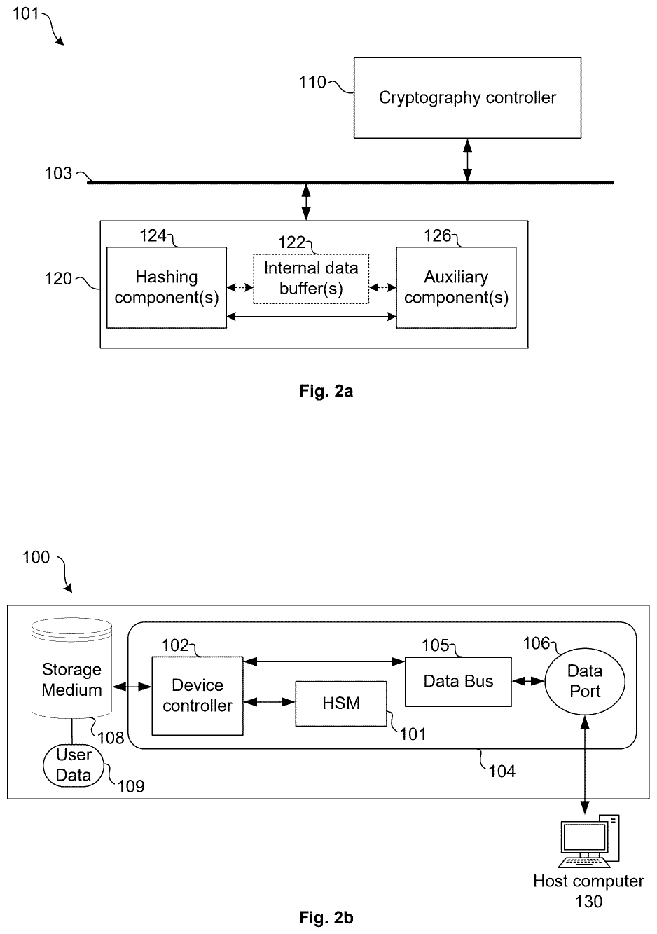

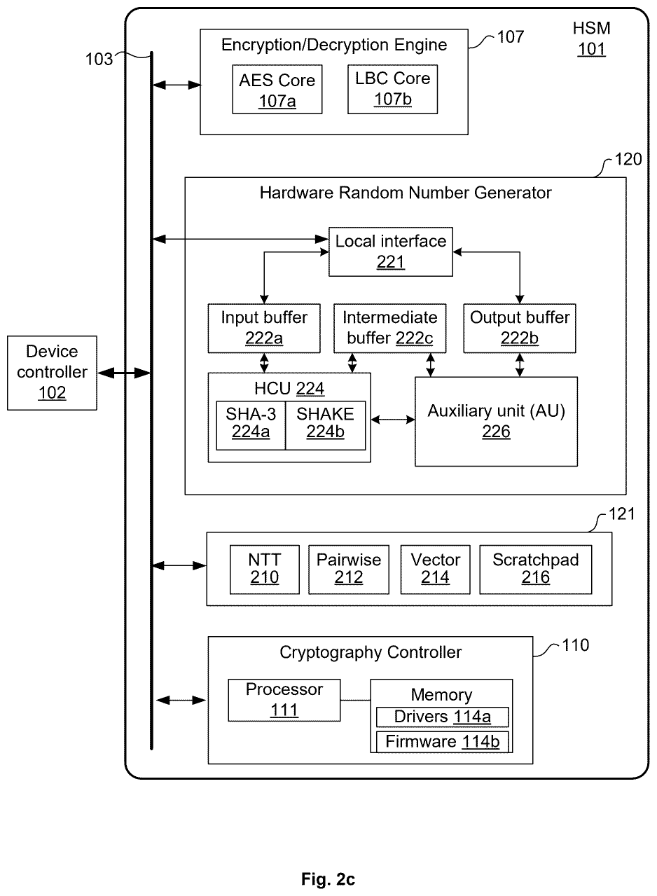

FIG. 2a illustrates an exemplary cryptographic system 101 for conducting cryptographic operations on a data storage device (DSD) using a cryptography module (CM) 120. CM 120 comprises one or more hardware components (“hashing components” 124) configured to perform one or more hashing operations, such as hash functions and/or extendable-output functions, and one or more hardware components (“auxiliary components” 126) configured to perform auxiliary logic operations on the hashing result. The hashing and auxiliary logic operations of the CM 120 are specific to at least one cryptographic operation implemented by the cryptographic system 101. For example, the CM 120 may be a hardware random number generator (HRNG) configured to generate random, or pseudorandom, coefficients (e.g., where cryptographic system 101 implements lattice-based cryptography), or to generate a cryptographic key directly (e.g., where system 101 implements password-based key derivation cryptography).

In some embodiments, the CM 120 generates the cryptographic output data in response to receiving input data from a cryptography controller 110 of the system 101 by way of a local bus 103. The input data comprises a cryptographic seed value generated by the cryptography controller 110 associated with the cryptographic operation(s). The CM 120 performs a hashing operation associated with the input data. For example, the hashing components 124 may apply a hashing function, or an extendable-output function, directly to the cryptographic seed value.

Alternatively, or in addition, the hashing components 124 may apply the hashing function, or extendable-output function, to a value derived from the cryptographic seed value of the input data (e.g., to a hash value generated from one or more previous applications of hashing and/or extendable-output function to the cryptographic seed). The result of the hashing operation is represented as hashing data. The hashing data generated by the hashing components 124 is provided to the more auxiliary components 126 of the CM 120. In some embodiments, the CM 120 stores the result of the hashing operation, as hashing data, in one or more internal data buffers 122 of the CM 120. In such embodiments, the one or more internal data buffers 122 are configured to transfer the hashing data to the auxiliary components 126 following receipt of the data from the hashing components 124. In other embodiments, the one or more hashing components 124 are configured to provide the hashing data to the one or more auxiliary components 126 directly (i.e., without first storing the hashing data in any internal data buffer(s) 122). In such embodiments, the CM 120 may not comprise the internal data buffer(s) 122. The CM 120 generates the cryptographic output data as a result of performing, using the auxiliary components 126, the one or more auxiliary operations on the hashing data (referred to as auxiliary data).

The CM 120 advantageously processes data received as input from the cryptography controller 110, and/or data generated by at least one of the hashing components 124 and auxiliary components 126, to produce the cryptographic output more efficiently compared to conventional cryptography systems. For example, the cryptographic system 101 provides improved performance by conducting both hashing and auxiliary processing operations using dedicated hardware, rather than relying on the execution of firmware by the processor (as in conventional system 10). By performing hashing operations and maintaining the hashing data generated from these operations internally within the module 120, the amount of data transferred between the CM 120 and the local bus 103 is reduced compared to using separate hardware accelerators (as in conventional system 10′).

The CM 120 is an integrated element according to the proposed technology. The term “integrated” refers to achieving a combination of physical and/or functional characteristics of conventionally modules, such as to generate a cryptographic output (e.g., a bit sequence with random, or pseudorandom, properties) using a data flow that is confined between internal components of the element. For example, the CM 120 provides the cryptographic system 101 with functionality for hashing an input value to generate a pseudorandom bit stream, for sampling the pseudorandom bit stream to a desired distribution, and/or for performing bitwise logical computations, such as exclusive-OR (XOR) on parts of the bit stream, without requiring a transfer of data between separate hashing and auxiliary modules (e.g., accelerators) via a bus.

In some embodiments, implementation of the CM 120 involves the use of one or more hardware components that are fabricated on, or integrated into, a single embedded chip (e.g., as one or more integrated circuit blocks disposed on one or more substrates of the chip). Thus, the combination of one or more integrated circuits to implement the CM 120 may form an integrated element comprising a plurality of hardware blocks based on the integrated circuit blocks. The implementation of the CM 120 as an integrated element may provide various advantages including the common use of components such as memory cells, ports, and/or interfaces by both the hashing components 124 and the auxiliary components 126. This may reduce an area of an embedded chip implementing the cryptography system 101, and its power consumption, by minimising the total number of circuit components, as compared to conventional systems 10 and 10′ which utilize a plurality of separate hardware modules, and/or the cryptography controller 110 to execute firmware. Further, components of the integrated element may be formed on a single laminated substrate, thereby providing resistance to physical tampering of the element.

In a first exemplary implementation of the cryptographic system 101, the CM 120 is configured to implement a sampling mode. When operating in the sampling mode, the CM 120 generates the cryptographic output as a set of pseudorandom coefficients. The pseudorandom coefficients are generated, by the auxiliary components 126, by shaping a distribution of pseudorandom bits, as generated by the hashing components 124, according to a sampling distribution defined by a sampling function. For example, in embodiments where the cryptography system 101 is configured to implement lattice-based cryptography, the auxiliary components 126 may perform sampling according to a uniform distribution, a binomial distribution, or a distribution representing a polynomial in the NTT domain.

In a second exemplary implementation of the cryptographic system 101, the CM 120 is configured to implement a key generation mode. When operating in the key generation mode, the CM 120 generates the cryptographic output as a pseudorandom bit string representing cryptographic key material, such as a key derived from an input user password according to a password-based key derivation function (PBKDF).

In other implementations of the cryptographic system 101, the CM 120 may be configured to implement any arbitrary mode that produces a cryptographic output by performing one or more auxiliary operations on the result of a hashing operation. That is, the components of the CM 120, including the hashing components 124, the auxiliary components 126, and the internal data buffers 122, are arbitrarily customizable according to the cryptographic operations of the cryptographic system 101. For example, the CM 120 may be configured to produce any arbitrary cryptographic output data by configuring the one or more auxiliary operations that are performed on the result of one or more hashing operations associated with an initially provided cryptographic seed value.

### Exemplary Data Storage Device With Cryptographic System

FIG. 2b illustrates an embodiment of the DSD 100 comprising a storage medium 108, a data path 104 for connecting the storage medium 108 to a host computing system 130, a device controller 102. The data path 104 provides data communication between the host 130 and the storage medium 108, and comprises a data port 106 configured to transmit data including at least user data between a host computer system 130 and the storage medium 108 of the DSD 100 via at least one data bus 105.

In some embodiments, the device controller 102 is connected between the data port 106 and the storage medium 108 such that data received from, or transmitted to, the host 130 via the data port 106 passes through the device controller 102 (i.e., such that the device controller 102 forms part of the data path 104), as depicted in FIG. 2b. In other embodiments, the device controller 102 is deployed externally to the data path 104 and is configured to intercept the relevant data as it passes through the path 104, initiate the appropriate encryption or decryption operations on the data, and re-inject the encrypted or decrypted data for transmission to the host 130 via data port 106, or to the storage medium 108.

Although the embodiment depicted in FIG. 2b shows the data path 104 as wholly encompassing the device controller 102, it will be appreciated that this is merely illustrative of the ability of one or more components of the device controller 102 to form part of the data path 104, depending on the implementation, and that it is not necessary that all components of the device controller 102 are included within the data path 104.

The storage medium 108 is non-transitory such as to retain the stored block data irrespective of whether the medium 108 is powered. The storage medium 108 may be a hard disk drive (HDD) with a rotating magnetic disk or a solid state drive (SSD) and its variations like SLC (Single Level Cell), eMLC (Enterprise Multi Level Cell), MLC (Multi Level Cell), TLC (Triple Level Cell), and QLC (Quadruple Level Cell), and combinations of the above such as SSHD. Any other type of non-volatile storage media may also be used, including emerging non-volatile memory such as Program in Place or Storage Class Memory (SCM), such as ReRam, PCM, and MRAM. Further, the storage medium 108 may be a block data storage device, such that the user content data 109 is written in blocks to the storage medium 108 and read in blocks from the storage medium 108.

The host computer 130 is configured to include a device driver and a data/power interface for communicating with the DSD 100 and providing it with power. The data and power interface operates over data port 106, which may be implemented as, for example, some form of USB port (e.g., USB-A, USB-8, USB-C, mini-USB, micro-USB, etc.), a Thunderbolt port, a Power over Ethernet (PoE) port, or a similar port.

The device controller 102 is configured to control the operation of the DSD 100. In some embodiments, the device controller 102 is configured to receive, interpret and execute commands received from host computer system 130 according to a predetermined command set, such as for example the standard Advanced Technology Attachment (ATA) or serial ATA (SATA) and/or ATA Packet Interface (ATAPI) command set, which is available from Technical Committee T13 noting that identical functionalities can be implemented within Trusted Computing Group (TCG) Opal, Small Computer System Interface (SCSI) and other proprietary architectures.

In some embodiments, the device controller 102 is implemented as an embedded device comprising a microcontroller, a memory, and one or more interfaces. The functions of the device controller 102 include, but are not limited to, generating: data representing an access state of the DSD 100 (i.e., whether the DSD 100 permits access of the host computer 130 to the storage medium 108); data transmission signals to control data transmission through data path 104; data encryption signals to direct the encryption or decryption of the user content data 109 via cryptographic operations performed by the DSD 100, for example by invoking a cryptography system or engine of the DSD 100 (as described herein); and, in some embodiments, control signals to control the operation of other components of the DSD 100.

In some embodiments, the DSD 100 includes one or more input components (not shown) configured to accept an input from a user. For example, the input components may include a: set of buttons; and a keypad, or a similar arrangement of mechanical components that collectively enable the selection of digits or characters for entering into the device 100. The input components may also include one or more communications components configured to receive data wirelessly, such as a Near Field Communication (NFC) or Radio-frequency identification (RFID) reader.

In exemplary implementations, the input components are configured to receive to receive authentication input from the user, such as a password, a personal identification code or number (e.g., a PIN), or a similar authentication value. The user operates the input components to provide the password, PIN, or similar authentication value as user input to the device controller 102. The device controller 102 is configured to process the user input for the purpose of performing one or more cryptographic operations on the user data 109.

### Cryptographic System

As shown in FIG. 2b, the DSD 100 further comprises a cryptographic system implemented as a hardware security module (HSM) 101.

FIG. 2c illustrates an example of the HSM 101 comprising a cryptography controller 110 and one or more cryptography modules (CMs), including a hardware random number generator (HRNG) 120 and an encryption/decryption (E/D) engine 107. The cryptography controller 110 is communicatively coupled to the one or more cryptography modules 107, 120 via a local bus 103. The local bus 103 is further configured to communicatively couple the HSM 101 to the device controller 102 of the DSD 100.

The cryptography controller 110 comprises: a CPU 111; a clock 112 in communication with the CPU 111; and a memory 114 configured to store one or more drivers 114a and a firmware 114b. The memory 114 is configured to exchange data with the CPU 111 and a power source (not shown), such as an internal battery, configured to power, at least, the CPU 111 and the clock 112. The firmware 114b and drivers 114a may be stored in a predetermined area of memory 114, or in one or more dedicated hardware modules, such as caches, registers, or a combination of these. The memory 114 stores data specific to the HSM 101, including at least an indication of the operational mode of the cryptography modules 107, 120. For example, the operational mode may be represented by a binary data access variable having values ‘0’ or ‘1’ representing the “hashing” and “auxiliary” modes of the HRNG 120 respectively.

The CPU 111 receives a clocking signal from clock 112, which is used to control the timing of instructions executed by the cryptography controller 110 and/or the one or more cryptography modules 107, 120 and sub-components (e.g., arithmetic operations conducted in the generation of random bit or byte sequences).

The CPU 111 is configured to execute program code stored within the system memory 114 to issue commands for controlling the cryptographic operations performed by the DSD 100. The function of the CPU 111 includes, but is not limited to: generating data representing an operational mode of the one or more cryptography modules 107, 120 (i.e., to determine a form or type of cryptographic output data produced by each of the modules 107, 120); receiving control instructions, from the device controller 102, to perform one or more cryptographic operations on data (e.g., to perform the encryption or decryption of all or a portion of user data 109); receiving the data, from the device controller 102 or an associated interface to the data path 104, on which to perform the one or more cryptographic operations; generating initial cryptographic input and control signals to invoke the HRNG 120 for performing the one or more cryptographic operations on the data; receiving, from the HRNG 120, cryptographic output data generated from the cryptographic input; and generating control signals to control the E/D engine 107 to perform the one or more cryptographic operations on the data, using the cryptographic output data obtained from the HRNG 120 according to the operational mode.

### Hardware Random Number Generator (HRNG) Module

The HRNG 120 comprises: one or more hashing components 124 implemented as a hashing calculation unit (HCU) 224; and one or more auxiliary components 126 implemented as an auxiliary unit (AU) 226. In the example shown in FIG. 2c, the HRNG 120 further comprises at least one data buffer 122, which includes an input buffer 222a, an output buffer 222b, and an intermediate buffer 222c. In some embodiments, the HRNG 120 is a physically integrated hardware module, where the HCU 224, the AU 226, and the optional buffers 222a, 222b, and 222c, are fabricated on the same physical chip, and/or using a common integrated circuit, with a tight coupling.

The HRNG 120 exemplified in FIG. 2c includes a local interface 221 configured to communicatively couple the HRNG 120 to the local bus 103. In some embodiments, the local interface 221 comprises a set of ports and/or connectors configured to attach the physical chip of the HRNG 120 to the local bus 103, thereby providing a secure means for the exchange of data between the HRNG 120 and the one or more other components of the HSM 101.

The HCU 224 comprises a set of hardware components configured to accelerate one or more cryptographic hashing functions and/or extendable-output (XOF) functions. For example, in the embodiment exemplified by FIG. 2c the HCU 224 comprises an embedded SHA-3 accelerator 224a configured to transform an input value into a fixed-size hash value (e.g., 256 or 512 bits as determined by the cryptography controller 110). HCU 224 further comprises one or more embedded SHAKE accelerators 224b, such as SHAKE-128 and/or SHAKE-256, configured to transform an input value into a variable length output. The term “hashing operation” is used herein to generally refer to performing a cryptographic hashing function or an extendable-output (XOF) function for the purpose of generating a hash value, or similar value with a random or pseudorandom characteristic, from a given input value.

The AU 226 comprises a set of hardware components configured to accelerate one or more cryptographic auxiliary functions for generating a cryptographic output (e.g., to enable the E/D engine 107 to perform the desired encryption and/or decryption functions). The auxiliary functions may vary according to the cryptography algorithm(s) implemented by the HSM 101.

### Encryption and Decryption Engine

The E/D engine 107 exemplarily comprises one or more cores for performing encryption and decryption functions to implement a cryptographic algorithm. For example, the E/D engine 107 may comprise an AES core 107a and/or a Lattice-based cryptography (LBC) core 107b. The E/D engine 107 is configured to use a cryptographic key to encrypt user content data 109 to be stored on the storage medium 108, and to decrypt the encrypted user content data 109 stored on the storage medium 108.

In some embodiments, E/D engine 107 is configured to generate the cryptographic key from cryptographic data generated by the HRNG 120, such as a set of random, or pseudorandom, bits or coefficients. In some embodiments, the cryptographic data generated by the HRNG 120 represents the cryptographic key for use by the E/D engine 107 to encrypt or decrypt the user content data 109.

The E/D engine 107 is invoked by the cryptography controller 110 of the HSM 101 in response to a request from the device controller 102. That is, the device controller 102 issues commands to the HSM 101, in response to communication with the host computer 130, thereby causing the HSM 101 to control a cryptographic state of the user content data 109 (i.e., encrypted or plain). In the example embodiment depicted in FIG. 2c, the E/D engine 107 is implemented as a distinct hardware module to the cryptography controller 110 and other cryptography modules such as the HRNG 120. In other embodiments, the E/D engine 107 is implemented as one or more routines in the firmware 114b of the cryptography controller 110.

In some embodiments, the HSM 101 optionally comprises additional hardware components 121, including for example a Number Theoretic Transform (NTT) accelerator 210, a pairwise accelerator 212, a vector operations accelerator 214, and/or a scratchpad accelerator 216. In some embodiments, the additional hardware components 210, 212, 214, 216 are implemented as part of the E/D engine 107, or by the AU 226 of the HRNG 120, for example to provide additional auxiliary functions. Alternatively, in some embodiments the additional hardware components are implemented as standalone modules of the HSM 101 with independent connections to the local bus 103.

In some embodiments, the NTT accelerator 210 is configured to perform polynomial multiplication operations, such as for example to assist with performing cryptographic operations for lattice-based algorithms. The NTT accelerator 210 transforms one or more polynomials defined by a set of pseudorandom coefficients into a domain where multiplication can be performed as point-wise multiplication, significantly reducing computational complexity. The pairwise accelerator 212 is configured to perform pairwise independent computation operations on pairs of data elements, minimizing the risk of data leakage or correlation attacks. The vector operations accelerator 214 is configured to execute large-scale vector computations, including addition, subtraction, and scalar multiplication, for large data sets. The scratchpad accelerator 216 is configured to provide a high-speed, temporary storage area for intermediate data during cryptographic computations, such as for example encryption and decryption operations performed by the E/D engine 107. For example the scratchpad accelerator 216 may be invoked by the E/D engine 107 to store intermediate results associated with key generation, encryption, decryption or related operations.

In some embodiments, the HSM 101 and the device controller 102 may be fabricated on the same physical chip. In other embodiments, the HSM 101 is fabricated separately to the device controller 102 with each configured as embedded systems. The HSM 101 delivers cryptographic services and secured key storage while the device controller 102 performs tasks related to the control of the DSD 100 and/or data exchanges with the host computer 130. In some embodiments, the HSM 101 is accessible only by the device controller 102 via a defined control interface (not shown) and is considered independent of the rest of the DSD 100 such that a security compromise of the device controller 102 has only limited impact on the security of the HSM 101.

The HSM 101 may perform one, some and/or all tasks described with respect to the cryptographic operations of the DSD 100 by using the cryptography controller 110, the HRNG 120, and the E/D engine 107. For example, the HSM 101 may be configured to receive data and control signals from the device controller 102, including data transmitted along the data path 104 and instructions to encrypt and/or decrypt the data. The HSM 101 may execute the procedures described herein at least partially by an internal controller and/or as integrated circuitry (i.e., as a fixed circuit or based on reconfigurable hardware such as a Field Programmable Gate Array (FPGA)).

### Method for Efficient Generation of Cryptographic Output

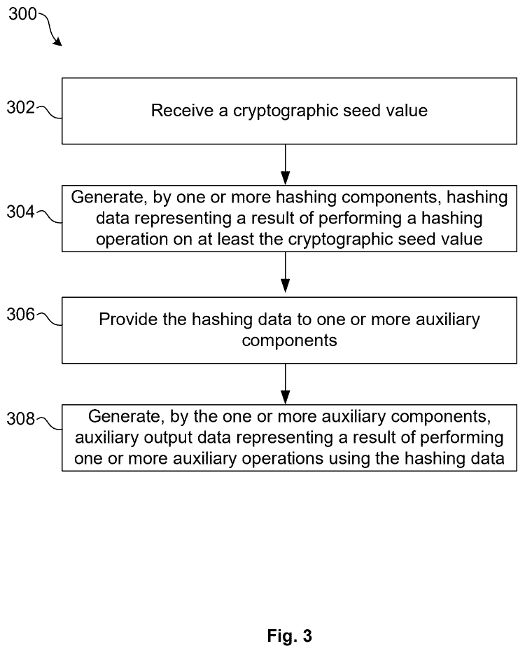

FIG. 3 illustrates a method 300 executed by a cryptography module of a cryptographic system, such as the HSM 101, to generate a cryptographic output for performing one or more cryptographic operations of a DSD 100.

At step 302, the HRNG 120 receive a cryptographic seed value from the controller 110 by way of the local bus 103. The cryptographic seed value may be received as part of input data that is generated by the cryptography controller 110, and is transmitted from the cryptography controller 110 to the HRNG 120 by way of the local bus 103. Internal components of the HRNG 120 access the input data, and other data placed on the local bus 103, via the local interface 221. In some embodiments, the input data comprises other data such as hashing data or other cryptographic data generated from the cryptographic seed value.

At step 304, the HCU 224 generates hashing data representing a result of performing a hashing operation on at least the cryptographic seed value. For some cryptographic operations, the HCU 224 is configured to generate the hashing data by performing the cryptographic hashing functions and/or extendable-output (XOF) functions directly on the cryptographic seed value. For other cryptographic operations, the HCU 224 is configured to generate the hashing data by performing the hashing function and/or extendable-output (XOF) function additionally on other data, for example to re-hash a hash value previously generated from the cryptographic seed value.

Cryptography controller 110 provides one or more hashing control parameters to the HCU 224 to determine the properties of the hashing value output by the HCU 224 in response to performing the cryptographic hashing functions and/or extendable-output (XOF) functions on the cryptographic seed value or other data. For example, the one or more hashing control parameters may include: an output length, as the desired length of the hash output (e.g., one of 224, 256, 384, and 512 bits, corresponding to SHA3-224, SHA3-256, SHA3-384, and SHA3-512, respectively); a rate, as the portion of the state that is used to absorb input and squeeze output (e.g., to determine the speed of the hashing process); a capacity value as related to the desired security level of the hashing defined as c=2n, where n is the output length in bits; and a state size as the total size of the internal state (e.g., 1600 bits for SHA-3); and a padding scheme to determine the method used to pad the cryptographic seed value (e.g., multi-rate padding for SHA-3).

Optionally, at step 306, the HRNG 120 provides the hashing data to the AU 226 of the HRNG 120 by storing the hashing data in at least one data buffer 222 of the HRNG 120. In some embodiments, the input buffer 222a and/or the intermediate buffer 222c may be configured to store the hashing data, as generated by the HCU 224, at a time prior to, or substantially simultaneously with, the generation of the auxiliary data by the AU 226 (i.e., such that the auxiliary functions are performed on the stored hashing data). By storing the result of the hashing operations, the HRNG 120 is able to generate the cryptographic output efficiently, even for algorithms requiring multiple processing iterations with each current iteration using a hashing result of a previous iteration.

In other embodiments, the HCU 224 is configured to transmit the hashing data directly to the AU 226. For example, the AU 226 may have an internal memory or storage configured to receive data from the HCU 224 at a predetermine rate. This allows the AU 226 to process the hashing data, which is generated by and maintained internally to the HRNG 120, without buffering the data flow between the HCU 224 and the AU 226.

At step 308, the HRNG 120 generates, using the AU 226, auxiliary output data representing a result of performing one or more auxiliary operations using the hashing data. The auxiliary data is provided as the cryptographic output data when the HRNG 120 operates in a mode of operation that utilizes the one or more auxiliary functions (i.e., an “auxiliary mode”).

In some embodiments, the HRNG 120 is configured to selectively transition its operation between: the auxiliary mode, in which the HRNG 120 generates the cryptographic output data as the auxiliary data; and a hashing mode, in which the HRNG 120 generates the cryptographic output data as the hashing data generated by the HCU 224. For example, in the embodiment shown in FIG. 2c the HRNG 120 comprises an output switch 129 that selectively controls the data provided as the cryptographic output data from the hashing data and auxiliary data streams according to the mode of operation.

For example, the output switch 129 is operated by the cryptography controller 110 to obtain hashing output data generated by the HCU 224 alternatively to the auxiliary data generated by the AU 226. This advantageously allows the HRNG 120 to provide equivalent functionality to a plurality of separate modules (e.g., hardware accelerators 14a and 14b) implemented in a conventional cryptography system. As the cryptography controller 110 may utilize the functionality of the HCU 224 independently to the AU 226, the need to implement an independent hashing accelerator within the HSM 101 is prevented.

In the embodiment depicted by FIG. 2c, the HRNG 120 comprises internal data buffers 222a, 222b, 222c which are configured to control the exchange of data between the HRNG 120 and other components of the HSM 101. For example, the input buffer 222a and output buffer 22b may be configured to respectively transmit data to HCU 124, and to receive data from AU 226, such as to isolate the respective components from any direct exchange of data with the local data bus 103 via its interface 221. This permits the HRNG 120 to receive data from and transmit data to the local data bus 103 at respective rates that differ from the rates of operation of the HCU 224 and AU 226. This also increases the amount of data that may be stored internally by the HRNG 120, thereby reducing data transfers over the local bus 103 and further improving performance.

It will be appreciated that in other configurations of the HRNG 120, one or more of the input buffer 222a, output buffer 222b, and intermediate buffer 222c may be omitted from the HRNG 120. For example, one or more of the HCU 224 and the AU 226 may be configured to receive input data from and transmit cryptographic output data to the local interface 103 without the input buffer 222a and/or the output buffer 222b. That is, the HRNG 120 may include only the input buffer 222a, only the output buffer 222b, or neither of the input buffer 222a and the output buffer 222b. The HCU 224 may be configured to transmit hashing data directly to the AU 226 without the intermediate buffer 222c irrespective of whether the HRNG 120 comprises any other data buffer (e.g., the input buffer 222a and/or the output buffer 222b).

Exemplary implementations of the HSM 101 and HRNG 120 to efficiently generate cryptographic output data for use in various cryptography algorithms, as suitable for securing user data 109 of the DSD 100, are described herein below.

### Sampling for the Generation of Pseudorandom Coefficients

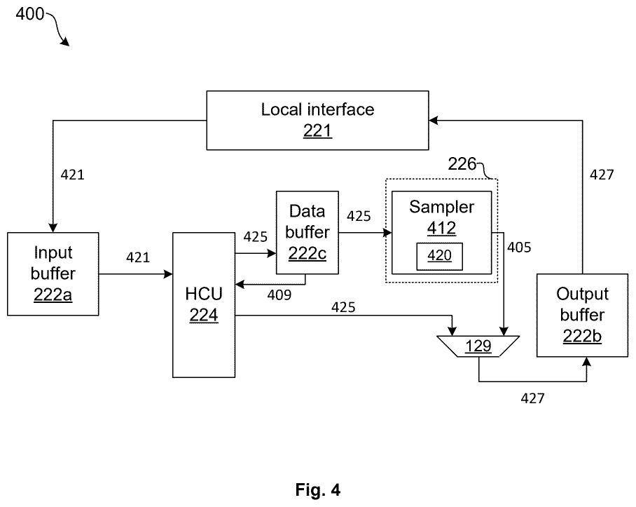

FIG. 4 illustrates a first implementation of the HRNG 120 of FIG. 2c as a hashing and sampling module (HS module) 400. The HS module 400 combines hashing and sampling functions of a hardware pseudorandom number generator, which are typically implemented by separate hardware modules in conventional cryptography systems, into a single integrated hardware module to generate pseudorandom coefficients for use in cryptographic operations.

In the embodiment of FIG. 4, the HS module 400 comprises a sampler unit 412 configured to implement a sampling function 420. The HS module 400 further comprises an intermediate data buffer 222c connected between the HCU 224 and the sampler unit 412.

The HS module 400 further comprises a switching device 129 configured to receive hashing data 425 from the HCU 224 and auxiliary data 405 from the sampler unit 412 as first and second inputs to the switching device 129. The switching device 129 determines a source of the cryptographic output data 427 that is controlled according to the mode of operation of the HS module 400. In the implementation of FIG. 4, the switching device 129 is a multiplexing circuit with a single control bit provided by the cryptography controller 110 to select the output data 427 as the hashing data 425 when the HS module 400 is operating in the hashing mode (control bit ‘0’) and the auxiliary data 405 when the HS module 400 is operating in the auxiliary mode (control bit ‘1’) respectively.

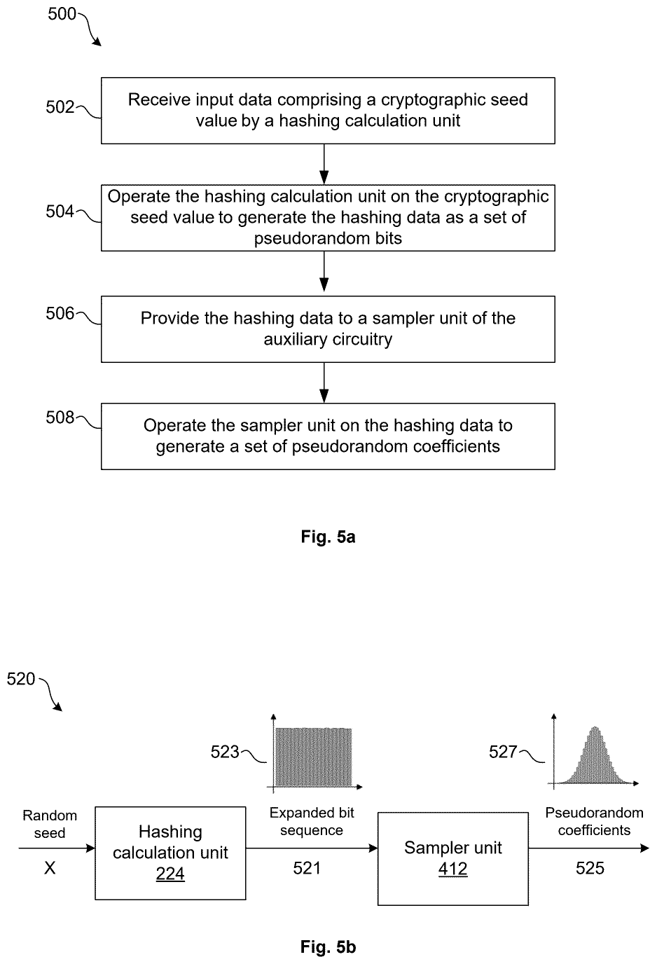

FIG. 5a illustrates a method 500 for using the HS module 400, to generate a set of pseudorandom bits for use by a cryptographic system, such as the HSM 101 of FIG. 2c.

At step 502, the HCU 224 receives input data 423 comprising the cryptographic seed value. In some embodiments, the cryptography controller 110 generates the cryptographic seed value using a true random number generator (TRNG). For example, the TRNG may be a routine implemented in the firmware 114b of the cryptography controller 110 which, when executed by the CPU 111, generates an output value based on an entropy source (e.g., a physical process such as electronic noise). In one example, the cryptography controller 110 is configured to output a 64-bit random value for each invocation of the firmware-based TRNG routine, which is transmitted to the HS module 400 as the cryptographic seed value.

The HS module 400 receives the cryptographic seed value from the cryptography controller 110 via interface 221. In some embodiments, the local bus 103 and/or the interface 221 is configured with one or more registers configured to provide temporary storage for the cryptographic seed value, and other data or control signals transmitted to the HS module 400.

In the embodiment depicted by FIG. 4, the cryptographic seed value is received from the interface 221 into the input buffer 222a. The input buffer 222a provides input data 421 comprising the cryptographic seed value to the HCU 224. Optionally, the HCU 224 receives the input data 421 directly from interface 221, for example in embodiments in which HS module 400 does not include input buffer 222a.

At step 504, the HS module 400 operates the HCU 224 on the cryptographic seed value of the input data 421 to generate the hashing data 425 as a set of pseudorandom bits representing an expansion of the cryptographic seed value using a hashing function (e.g., SHA-3) or an extendable-output function. For example, the HCU 224 may be configured to expand an initial 64-bit true random seed using a SHA-3 function (e.g., SHA3-256 or SHA3-512) to generate a hash value of a fixed number of bits (e.g., n=256 or 512 bits).

At step 506, the HS module 400 provides the hashing data 425 to the sampler unit 412. In some embodiments, the hashing data 425 is transmitted directly to the sampler unit 412 by the HCU 224. Alternatively, as shown in the embodiment depicted by FIG. 4, the hashing data 425 is provided to the sampler unit 412 via the intermediate data buffer 222c. The intermediate data buffer 222c is a first-in-first-out (FIFO) buffer configured to read the hashing data from the HCU 224, store the hashing data, and transmit the hashing data, including the set of pseudorandom bits, to the sampler unit 412. In some embodiments, hashing data is removed from the data buffer 222c (or flagged to be overwritten) following transmission of the hashing data to the sampler unit 412.

In some embodiments, the intermediate data buffer 222c is implemented as a dedicated portion of memory for block storage of the hashing data 425 generated by the HCU 224. The intermediate data buffer 222c receives hashing data 425 from the HCU 224 at a read rate R_{Bread} and transmits the hashing data 425 to the sampler unit 412 at a write rate R_{Bwrite}. In some embodiments, the size of the intermediate data buffer 222c is determined by one or more of: the maximum size of the hashing data 425 (i.e., the length of the bit sequence of the pseudorandom values generated by hashing each cryptographic seed value), which is dependent on the hashing function used by the HCU 224; and any difference in the read and write rates R_{Bread} and R_{Bwrite} of the buffer 222c.

In some embodiments, the size of the intermediate data buffer 222c is minimized by setting the size to a value that is small enough to provide the sampling unit 412 with a minimum amount of data to operate with. For example, in some implementations the size of the intermediate data buffer may be a few dozen Bytes (e.g., up to 32 Bytes), which is typically smaller than the maximum size of the hashing data (which may be several KBytes).

For example, using SHA3-256 to hash each cryptographic seed results in the HCU 224 generating a pseudorandom value sequence of a fixed-length of 256 bits (32 bytes) for the hashing data 425. In this example, the size of the intermediate data buffer 222c may be set to 1 KB to permit storage of hashing data 425 representing 32 pseudorandom value sequences (i.e., results of hashing each of 32 input cryptographic seed values by the HCU 224).

At step 508, the HS module 400 operates the sampler unit 412 on the hashing data 425 to generate the auxiliary data 405, which is output as the cryptographic output data 427 when the HS module 400 is in the auxiliary mode. The sampler unit 412 generates the auxiliary data 405 as a set of pseudorandom coefficients by mapping the set of pseudorandom bits to a sampling distribution of the sampling function 420.

FIG. 5b illustrates a data flow 520 of a sampling process performed by the sampler unit 412. The sampler unit 412 receives a set of pseudorandom bits (or bytes) as a sampling input 521. The sampling input 521 is generated by a hashing component, such as the HCU 224 as described herein, from an initial value X (e.g., a random seed value). Sampler unit 412 uses the sampling function 420 to shape a distribution of the sampling input (e.g. a uniform distribution 523) into a set of pseudorandom coefficients as the sampling output 525. The sampling output 525 represents a sample from a distribution that is computationally indistinguishable from the desired distribution of the selected sampling function (e.g., a binomial distribution 527).

The sampler unit 412 may be configured with the one or more candidate sampling functions from which the sampling function 420 is selected according to the cryptographic operations performed by the HSM 101. In some embodiments, the sampling distribution of the sampling function 420 is one of: a uniform distribution; a distribution representing a polynomial in the NTT domain; and a centred binomial distribution. For example, the HSM 101 may be configured to implement lattice-based cryptography according to the CRYSTALS-Kyber and CRYSTALS-Dilithium algorithms. Corresponding sampling functions 420 include SampleNTT SamplePolyCBD RejNTTPoly RejBoundedPoly BitUnpack as described by references [1] and [2], the contents of which are incorporated herein.

In the embodiment depicted by FIG. 4, the cryptographic output data 427 is received by the output buffer 222b which is configured to provide the cryptographic output data 427 to the interface 221. The input buffer 222a and the output buffer 222b thereby isolate the HCU 224 and the sampler unit 412 from any direct exchange of data with the interface 221 to the local data bus 103. In other embodiments, the HS module 400 does not comprise an output buffer 222b and the interface 221 receives the cryptographic output data 427 from the switching device 129, or receives the auxiliary data 405 from the sampler unit 412.

In some embodiments, the pseudorandom coefficients generated by the sampler unit 412, are used as coefficients of a sampled polynomial to secure user data 109 via a lattice-based cryptographic algorithm. For example, the cryptography controller 110 may be configured to transmit the cryptographic output data 427 together with control data instructing the E/D engine 107 to perform encryption and/or decryption of user data 109 by using the pseudorandom coefficients to generate a corresponding encryption key.

In some embodiments, the data buffer 222c is configured to provide one or more control signals 409 to the HCU 224 to indicate a state of the data buffer 222c. For example, the data buffer 222c may generate and transmit signal data to the HCU 224 to indicate a state of the data buffer 222c. In some embodiments, the state of the data buffer 222c represents a state of the memory of the data buffer 222c, for example as one of: ‘full’ when the memory has no capacity to store additional data (i.e., when it is entirely used to store hashing data that is not flagged to be overridden); and ‘available’ when the memory has capacity to store additional hashing data.

In some embodiments, the data buffer 222c is configured to compensate for a difference in a rate of generation of the hashing data by the HCU 224 Rₕₐₛₕ, and a rate of generation of the sampling output Rₛₐₘₚₗₑ by the sampler unit 412. For example, by setting the read and write rates R_{Bread} and R_{Bwrite} of the buffer 222c to the respective rates of the generation of the hashing data Rₕₐₛₕ and the sampling data Rₛₐₘₚₗₑ, the data buffer 222c stores hashing data that would otherwise be discarded by the sampler unit 412 when Rₕₐₛₕ>Rₛₐₘₚₗₑ, for a predetermined period of time.

In some embodiments, the HCU 224 is operated to control a rate of generation of the hashing data 425. For example, the HS module 400 may process the signal data generated by the data buffer 222c, and in response to determining that the state of the data buffer 222c is ‘full’ issue a control signal to decrease the rate of generation of the hashing data 425.

Alternatively, or in addition, in some embodiments the HS module 400 is configured to determine a difference in the rate of generation of the hashing data 425 and the auxiliary data 405, for example based on the difference in the hashing and sampling rates Rₕₐₛₕ and Rₛₐₘₚₗₑ of the HCU 224 and the sampler unit 412 respectively. In some embodiments, the HS module 400 may be configured to: determine whether the hashing rate Rₕₐₛₕ exceeds the sampling rate Rₛₐₘₚₗₑ by at least a predetermined threshold value λ; and in response to a positive determination (i.e., if Rₕₐₛₕ−Rₛₐₘₚₗₑ>λ), perform a masking of the hashing operation conducted by the HCU 224.

In some embodiments, the HS module 400 is configured to perform a set of masking operations with predetermined characteristics without determining the actual value of the hashing rate and/or sampling rate during operation. For example, where the HS module 400 is configured with a combination of a hashing function and a sampler function each having respective fixed and predetermined rates Rₕₐₛₕ and Rₛₐₘₚₗₑ, the rate difference Rₕₐₛₕ−Rₛₐₘₚₗₑ is also fixed and may be predetermined, allowing determination of a set of masking operations to be performed by the HS module 400 during operation (i.e., to match to the fixed predetermined rate difference value) without needing to dynamically determine the corresponding rates.

In some embodiments, masking of the hashing operation involves the HCU 224 performing one or more redundant calculations associated with the hashing operation. For example, the HCU 224 may be configured to split the cryptographic seed value X into a plurality of (d+1) shares, where d≥1 is the masking order, (X₁, X₂, . . . , X_{d+1}) such that (X=X₁⊕X₂⊕. . . ⊕X_{d+1}). The hashing function (f) is performed on the shares of the seed value X independently, resulting in (f (X₁), f (X₂), . . . , f (X_{d+1})). The HCU 224 combines the results of hashing each share to obtain the result of hashing the initially provided value f (X), thereby increasing the number of computations required to obtain the hashing data 425 (i.e., compared to applying hashing function (f) directly to the cryptographic seed value X).

In some embodiments, the masking of the hashing operation involves completing a calculation of the hashing operation by performing each of a plurality of parts of the calculation over a respective plurality of clock cycles. To achieve this, the HCU 224 may break down the process of executing the hashing function (f) on the cryptographic seed value X into a series of sub-steps that are executed sequentially across the plurality of clock cycles. The HCU 224 may distribute the execution of the hashing function over the plurality of clock cycles with or without the use of redundant calculations associated with the hashing.

In one example, the HCU 224 is configured to execute computations associated with independently performing the hashing function (f) on each share of the seed value X in distinct clock cycles (i.e., such that the values of f (X₁), f (X₂), . . . , f (X_{d+1}) are computed consecutively).

In an alternative example, the HCU 224 is configured to hash the initially provided cryptographic seed value X to generate hash value f (X) in a clock cycle distributed process including:
(i) Initializing the internal state of the hash function (e.g., in a first clock cycle), such as by setting up a 1600-bit state array to predefined values for SHA-3;
(ii) Absorbing the input data into the state array in chunks, where each chunk is XORed with a portion of the state array (e.g., in clock cycles 2 to N). For example, if the input data is divided into 8-byte blocks, each block is processed in a separate clock cycle;
(iii) Applying each round of a permutation function to the state array over several clock cycles, (e.g., in clock cycles N+1 to M): For example, in SHA-3, the Keccak-f[1600] permutation consists of 24 rounds, and the HCU 224 spreads each round over multiple clock cycles;
(iv) Squeezing the output data from the state array by extracting the hash value in blocks, where each block is processed in a separate clock cycle (e.g., in clock cycles M+1 to P).

In some embodiments, the HS module 400 is configured to perform masking on the auxiliary data instead of the hashing data. For example, the HS module 400 may be configured to: determine whether the sampling rate Rₛₐₘₚₗₑ exceeds the hashing rate Rₕₐₛₕ by at least the predetermined threshold value λ, or another threshold value; and in response to a positive determination (i.e., if Rₛₐₘₚₗₑ−Rₕₐₛₕ>λ), perform a masking of a sampling operation conducted by the sampling unit 412 in an analogous manner to the masking of the hashing described herein (e.g., by performing one or more redundant calculations associated with the sampling operation, and/or by completing a calculation of the sampling operation by performing each of a plurality of parts of the calculation over a respective plurality of clock cycles).

### Password-Based Key Derivation (PBKD)

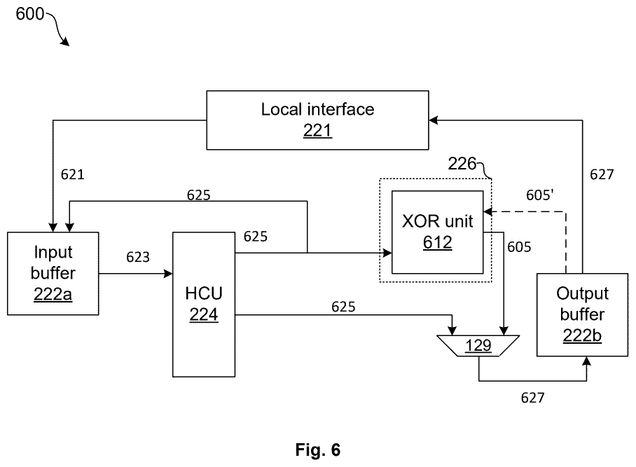

FIG. 6 illustrates a second implementation of the HRNG 120 of FIG. 2c as a password-based key derivation module (PBKD module) 600. The PBKD module 600 is an integrated hardware module that performs iterative hashing and XOR operations to transform an input seed value with low entropy into a pseudorandom output. In some embodiments, the PBKD module 600 is utilized to implement the password-based key derivation algorithm described by reference [3], the contents of which is incorporated herein.

In the embodiment of FIG. 6, the PBKD module 600 comprises an XOR unit 612 configured to perform a bit-wise exclusive-or operation (XOR operation) on two sets of bits B₁ and B₂ that are input to the XOR unit 612 in a given iteration of processing. the cryptographic seed value of the input data (621) comprises a user password value. The XOR unit 612 is connected to the HCU 224 and to at least one data buffer, such as the output buffer 222b, to receive the first and second sets of bits B₁ and B₂ as described herein. The HCU 224 and the XOR unit 612 perform respective operations to generate the hashing data 625 and the auxiliary data 605 over a predetermined plurality of iterations, such that the auxiliary data 605 represents at least part of a secure cryptographic key (e.g., that may be used to secure user data 109 via an encryption operation).

The PBKD module 600 further comprises switching device 129 configured to receive hashing data 625 from the HCU 224 and auxiliary data 605 from the XOR unit 612 as first and second inputs to the switching device 129. The switching device 129 determines a source of the cryptographic output data 627 that is controlled according to the mode of operation of the PBKD module 600. In the implementation of FIG. 6, the switching device 129 is a multiplexing circuit with a single control bit provided by the cryptography controller 110 to select the output data 627 the hashing data 625 when the PBKD module 600 is operating in the hashing mode (control bit ‘0’) and the auxiliary data 605 when the PBKD module 600 is operating in the auxiliary mode (control bit ‘1’) respectively.

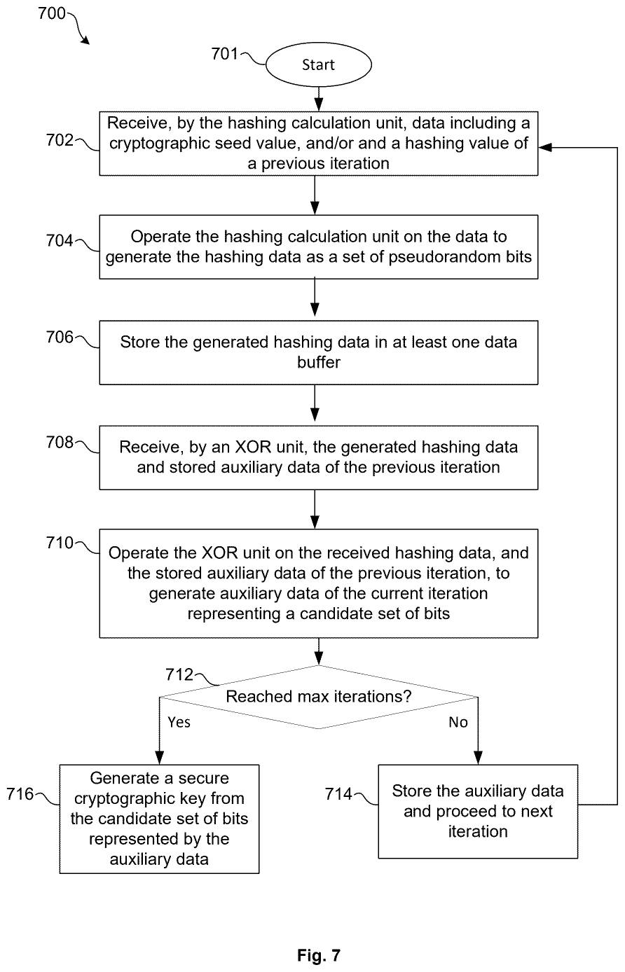

FIG. 7 illustrates a method 700 for using the PBKD module 600 to generate a set of pseudorandom bits for deriving a cryptographic key using a cryptographic system, such as the HSM 101 of FIG. 2c. With reference to FIG. 1c, the method steps 702 to 716 are executed using the PBKD 600 to generate each block Tⱼ of a cryptographic master key MK over a set of C iterations i={1, . . . , C}.

As shown in FIG. 7, at step 701 the method 700 is initiated by setting the iteration count i to 1, and the PBKD module 600 is set to operate in the PBKD mode, such that the cryptographic output data 627 is generated as the auxiliary data 605 by the XOR unit 612 in each iteration of processing. In some embodiments, the data stored by one or more data buffers of the PBKD 600 is cleared during initialization (e.g., to set the values of any data stored by an input and/or output buffer to ‘0’).

At step 702, the HCU 224 receives data 623 to perform a hashing operation of the current iteration i. In the first iteration i=1, the data 623 includes the input data 621 as received from the local bus 103 via interface 221, where the input data comprises at least a cryptographic seed value (as in step 302 of method 300). The cryptographic seed value comprises a user password value P (e.g., a password, PIN, or passphrase, represented as a binary string).

In some embodiments, in the first iteration i=1 the password value P is combined with a salt value Sⱼ to form the cryptographic seed value (e.g., using bit string concatenation as P ∥Sⱼ), where the salt value Sⱼ may be a constant value or a different value for each respective block Tⱼ.

In subsequent iterations i=2, . . . , C, the data 623 includes the input data 621 which comprises the user password value P received from the local bus 103 and stored hashing data comprising a hashing value Hᵢ₋₁ generated by the HCU 224 in the previous iteration i-1. Respective sets of bits representing the user password value P of the input data 621 and the hashing value Hᵢ₋₁ of the stored hashing data are combined to produce a set of pseudorandom bits represented by the data 623 (i.e., as P ∥Hᵢ₋₁).

At step 704, the PBKD module 600 operates the HCU 224 on the data 623 to generate the hashing data 625 of the current iteration i. The hashing data 625 comprises a set of pseudorandom bits representing an expansion of the value represented by data 623. That is, hashing data 625 of the current iteration i represents a value Hᵢ generated, by the HCU 224, by hashing the cryptographic seed value of the input data 621, being the user password value P optionally combined with salt value Sj, and the value Hᵢ₋₁ of the hashing data generated by the HCU 224 in the previous iteration (only for iterations i>1).

At step 706, the PBKD module 600 is configured to store the hashing data representing the hash value Hᵢ of current iteration i in at least one data buffer of the PBKD module 600. In the embodiment depicted in FIG. 6, the hashing data 625 is stored in the input buffer 222a. Storing both the input data 621 and the hashing data 625 in the same input buffer 222a may improve the efficiency of preparing data 623 for input into the HCU 224 in the next iteration (i.e., since the data representing the password value P and the previous hash value Hᵢ₋₁ can be extracted from respective regions of memory of the HRNG 101 that are physically or logically close together, thereby increasing the speed of the data retrieval). In other embodiments, the PBKD 600 may include one or more other data buffers configured to store the hashing data 625.

At step 708, the XOR unit 612 receives at least one of: the hashing data generated in step 704; and the stored auxiliary data of the previous iteration i-1 (e.g., from the output buffer 222b). With reference to FIG. 6, in the current iteration of processing i, the XOR unit 612 generates the auxiliary data 605 to represent the result Bout of the bit-wise XOR operation Bout=B₁⊕B₂. The XOR unit 612 is configured to receive the first set of bits B₁ as the hashing data 625 generated by the HCU 224 (i.e., such that B1 represents the hash value Hᵢ).

For iterations i>1, the XOR unit 612 also receives the second set of bits B₂ as the auxiliary data 605′ generated by the XOR unit 612 in the previous iteration of processing (i.e., such that B₂ is equal to Bₒᵤₜ from iteration i-1). In the embodiment depicted by FIG. 6, the auxiliary data 605′ of the previous iteration is stored in the output buffer 222b in previous iteration i-1 and retrieved by the XOR unit 612 in the current iteration i. The input buffer 222a receives and stores the hashing data 625 currently generated by the HCU 224, and provides, to the HCU 224 the hashing data of the previous iteration. In other embodiments, the PBKD 600 may include one or more other data buffers configured to store the hashing data 625 and/or the auxiliary data 605′ of the previous iteration. In some embodiments, for the first iteration i=1 the XOR unit 612 is configured to set the second set of bits B₂ to a bit string consisting entirely of zero bit values, or to obtain the zero bit string from initialized data of the output buffer 222b.

At step 710, the PBKD module 600 operates the XOR unit 612 perform an XOR operation on the received hashing data 625, and the auxiliary data 605′ of the previous iteration, to generate auxiliary data 605 of the current iteration. As shown in FIG. 6, the auxiliary data 605 generated in the ith iteration represents the set of bits resulting from performing the operation Hᵢ⊕Hᵢ₋₁ (with H₀ being the zero bit string). The auxiliary data 605 thereby represents a candidate set of bits generated by the PBKD module 600 in one iteration of processing towards the generation of the cryptographic data representing block Tⱼ of cryptographic key MK.

At step 712, the iteration value i is checked against the maximum iteration count C, which is set to a predetermined value (e.g., C=10,000) during initialization (i.e., at step 701). In some embodiments, check is performed by the cryptography controller 110 which operates the PBKD module 600.

In response to the iteration value i being less than the maximum iteration count C, at step 714 the operation of the PBKD module 600 proceeds to the next iteration with the auxiliary data 605 stored in the output buffer 222b. The cryptography module 110 operates the PBKD module 600 by repeating steps 702 to 712 over the plurality of iterations I−{1, . . . , C}, until the final iteration terminates. After the final iteration, the candidate set of bits represented by auxiliary data 605 represents at least part of a secure cryptographic key (i.e., key block Tⱼ).

Optionally, at step 716 the auxiliary data 605 of the final iteration is used to generate the secure cryptographic key. For example, the cryptography controller 110 may be configured to obtain the auxiliary data 605 representing key block Tⱼ, and combine the key block Tⱼ with one or more other key blocks to construct a cryptographic master key mk, for example by concatenating the binary strings of respective L key blocks (e.g., as mk=T1 ∥. . . ∥T_{L}).

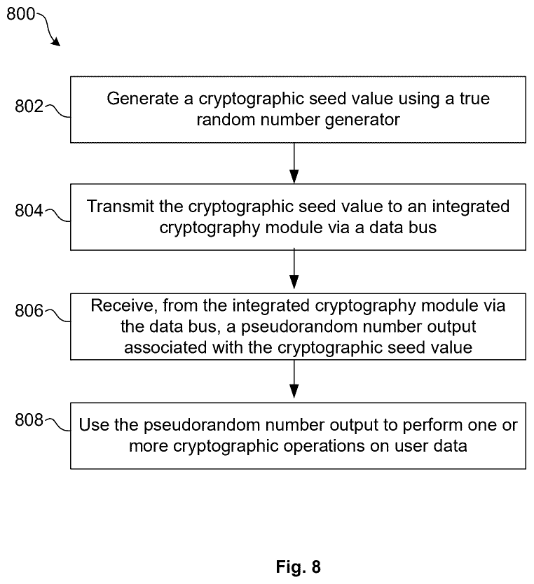

FIG. 8 illustrates a method performed by the cryptography controller 110 to control a cryptography module, such as HRNG 120 depicted in FIG. 2c, to generate cryptographic output data for performing a cryptographic operation on user data. Device controller 102 initiates the cryptographic operation by transmitting data and control signals to the cryptography controller 110 via local bus 103.

In response to receiving the data and control signals, at step 802 the cryptography controller 110 generates a cryptographic seed value to provide as input to the HRNG 120. For example, to generate the cryptographic seed value the processor 111 may execute a true random number generator function implemented in the firmware 114b of the controller 110.

At step 804, the cryptography controller 110 transmits the cryptographic seed value to the HRNG 120 as input data via the local data bus 103. The HRNG 120 generates cryptographic output data representing one or more random, or pseudorandom, number output values based on the cryptographic seed value of the input data, for example according to methods 300, 500, or 700 as described herein.

At step 806, the cryptography controller 110 receives, from the HRNG 120 via the data bus 103, the cryptographic output data representing the random, or pseudorandom, number output associated with the cryptographic seed value.

At step 808 the cryptography controller 110 uses the cryptographic output data to perform one or more cryptographic operations on user data 109. For example, the cryptography controller 110 may perform operations including, but not limited to, key exchange, key decapsulation or encapsulation, and/or key generation according to a module-lattice-based encryption process using cryptographic output data representing a set of pseudorandom coefficients obtained from the HRNG 120 configured as HS module 400.

In another example, cryptography controller 110 may perform a password-based key derivation function (PBKDF) on a password provided by a user by utilizing cryptographic output data obtained from the HRNG 120 configured as PBKD module 600 (e.g., to form a cryptographic master key mk on key blocks {T} generated from the execution of method 700). The cryptographic master key mk may be used, by the cryptography module 110, the encryption engine 107, and/or one or more other modules of the HSM 101, to generate 1) one or more Data Protection Keys (DPKs) to protect data, or 2) an intermediate key to protect one or more existing DPKs or generated from the cryptographic master key.

It will be appreciated by persons skilled in the art that the proposed techniques for generating cryptographic outputs comprising random or pseudorandom number values, as illustrated in this disclosure, are not limited to the context of performing cryptographic operations of a data storage device. The proposed techniques may equally be applied to performing cryptographic operations on data associated with various devices, systems and/or apparatus suitable to implement the methods described herein. The proposed techniques may be provided using a wide variety of devices or apparatuses suitable to implement the described cryptography modules with integrated hardware components and/or functionalities, for example by using a single integrated circuit (IC) or a set of ICs (e.g., a chip set).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### REFERENCES

[1] National Institution for Standards and Technology (NIST), FIPS 203—Module-Lattice-Based Key-Encapsulation Mechanism Standard, https://doi.org/10.6028/NIST.FIPS.203.ipd
[2] National Institution for Standards and Technology (NIST), FIPS 204—Module-Lattice-Based Digital Signature Standard, https://doi.org/10.6028/NIST.FIPS.204.ipd
[3] NIST Special Publication 800-132 Recommendation for Password-Based Key Derivation Part 1: Storage Applications https://nvlpubs.nist.gov/nistpubs/Legacy/SP/nistspecialpublication800-132.pdf

1. A data storage device comprising:
a non-volatile storage medium configured to store user data;
a data port configured to transmit at least user data between a host computer system and the data storage device by way of a data path;
a cryptography module comprising one or more hashing components and one or more auxiliary components, wherein the cryptography module receives the user data and generates cryptographic output data; and
a controller configured to control the cryptography module via a local bus to cause the cryptography module to generate the cryptographic output data by performing one or more cryptographic operations on the user data,
wherein the cryptography module is implemented as an integrated hardware element configured to:
receive a cryptographic seed value from the controller by way of the local bus;
generate, using the one or more hashing components, hashing data representing a result of performing a hashing operation on the cryptographic seed value;
provide the hashing data to the one or more auxiliary components; and
generate, using the one or more auxiliary components, auxiliary data representing a result of performing one or more auxiliary operations using the hashing data.

2. The device of claim 1, wherein the cryptography module is configured to selectively transition between operating in: a first mode in which the cryptography module generates the cryptographic output data as the auxiliary data; and a second mode in which the cryptography module generates the cryptographic output data as the hashing data.

3. The device of claim 2, wherein the cryptography module comprises one or more of:
an input buffer configured to: receive input data comprising the cryptographic seed value from an interface to the local bus; and provide at least the input data to the one or more hashing components;
an intermediate data buffer configured to: receive the hashing data from the one or more hashing components; store the hashing data; and provide the hashing data to the one or more auxiliary components; and
an output buffer configured to: receive the hashing data when the cryptography module is operated in the second mode; receive the auxiliary data when the cryptography module is operated in the first mode; and provide the hashing data or the cryptographic output data to the interface.

4. The device of claim 3, wherein:
the one or more auxiliary components comprises a sampler unit configured to generate the auxiliary data as a set of pseudorandom coefficients by mapping the set of pseudorandom bits to a sampling distribution of a sampling function;
the one or more hashing components comprises a hashing calculation unit; and
the device further comprises the intermediate data buffer connected to the hashing calculation unit and the sampler unit, wherein the intermediate data buffer is configured to:
read the hashing data from the hashing calculation unit, wherein the hashing data comprises a set of pseudorandom bits representing an expansion of the cryptographic seed value using a hashing function or an extendable-output function;
store the hashing data; and
transmit the hashing data to the sampler unit.

5. The device of claim 4, wherein the intermediate data buffer is configured to provide one or more control signals to the hashing calculation unit to indicate a state of the data buffer.

6. The device of claim 4, wherein the cryptography module is further configured to:
(i) determine whether a rate of generation of the hashing data exceeds a rate of generation of the pseudorandom coefficients by at least a predetermined threshold value; and
(ii) in response to a positive determination in step (i), perform a masking of the hashing operation.

7. The device of claim 6, wherein the masking the hashing operation comprises one or more of:
performing one or more redundant calculations associated with the hashing operation during one or more clock cycles; and
completing a calculation of the hashing operation by performing each of a plurality of parts of the calculation over a respective plurality of clock cycles.

8. The device of claim 4, wherein the sampling distribution is one of: a uniform distribution; a distribution representing a polynomial in a NTT domain; and a centred binomial distribution.

9. The device of claim 3, wherein:
the one or more auxiliary components comprises an XOR unit;
the cryptographic seed value of the input data comprises a user password value; and
the hashing calculation unit and the XOR unit perform respective operations to generate the hashing data and the auxiliary data over a predetermined plurality of iterations, to generate the auxiliary data representing at least part of a secure cryptographic key.

10. The device of claim 9, wherein the XOR unit is configured to, during a current iteration:
receive the hashing data generated by the hashing calculation unit, wherein the hashing data comprises a set of pseudorandom bits representing an expansion of at least one of: a value represented by hashing data of a previous iteration; and the cryptographic seed value;
receive auxiliary data of the previous iteration from the output buffer; and
perform a bitwise exclusive-or operation on the received hashing data, and the auxiliary data of the previous iteration, to generate the auxiliary data of the current iteration as a set of candidate bits.

11. The device of claim 10, wherein the input buffer is further configured to:
receive, during the current iteration, the hashing data generated the hashing calculation unit, and
provide, to the hashing calculation unit during the current iteration, the hashing data of the previous iteration.

12. The device of claim 1, wherein the one or more cryptographic operations are Lattice-based cryptographic operations.

13. A method executed by an integrated hardware cryptography module of a data storage device, to generate a cryptographic output for performing one or more cryptographic operations, the method comprising:
receivinga cryptographic seed value from a local bus of the data storage device;
generating, by a hashing calculation unit of the cryptography module, hashing data representing a result of performing a hashing operation on the cryptographic seed value; and
generating, by an auxiliary unit of the cryptography module, cryptographic output data representing a result of performing one or more auxiliary operations using the hashing data.

14. The method of claim 13, wherein the auxiliary unit is a sampler unit configured to implement a sampling function, and the method further comprising:
receiving input data comprising the cryptographic seed value by the hashing calculation unit;
operating the hashing calculation unit on the input data to generate the hashing data as a set of pseudorandom bits representing an expansion of the cryptographic seed value using a hashing function or an extendable-output function;
providing the hashing data to the sampler unit; and
operating the sampler unit on the hashing data to generate a set of pseudorandom coefficients by mapping the set of pseudorandom bits to a sampling distribution of the sampling function.

15. The method of claim 14, further comprising:
(i) determining whether a rate of generation of the hashing data exceeds a rate of generation of the pseudorandom coefficients by at least a predetermined threshold value; and
(ii) in response to a positive determination in step (i), performing a masking of the hashing operation.

16. The method of claim 15, wherein the masking of the hashing operation comprises one or more of:
performing one or more redundant calculations associated with the hashing operation during one or more clock cycles; and
completing a calculation of the hashing operation by performing each of a plurality of parts of the calculation over a respective plurality of clock cycles.

17. The method of claim 13, wherein the cryptographic seed value comprises a user password value, wherein the auxiliary unit is an XOR unit, and wherein the method further comprises, in a current iteration of processing:
(i) receiving, by the hashing calculation unit, data including at least one of: input data comprising the cryptographic seed value; and stored hashing data of a previous iteration;
(ii) operating the hashing calculation unit on the data to generate the hashing data comprising a set of pseudorandom bits representing an expansion of at least one of: a value represented by the hashing data of the previous iteration; and the cryptographic seed value of the input data;
(iii) storing the hashing data generated in step (ii) in at least one data buffer of the cryptography module;
(iv) receiving, at the XOR unit, the hashing data generated in step (ii) and stored auxiliary data of the previous iteration; and
(v) operating the XOR unit to perform a bitwise exclusive-or operation on the received hashing data, and the auxiliary data of the previous iteration, to generate auxiliary data of the current iteration representing a candidate set of bits.

18. The method of claim 17, wherein steps (i) to (v) are performed over a predetermined plurality of iterations, to generate at least part of a secure cryptographic key from the candidate set of bits represented by auxiliary data of a final iteration of the steps (i) to (v).

19. The method of claim 18, further comprising:
storing the hashing data generated in step (ii) in an input buffer of the cryptography module, wherein the input buffer is configured to receive the input data from an interface to the local bus; and
receiving, by the hashing calculation unit from the input buffer, the input data and the stored hashing data of the previous iteration.

20. A cryptographic system of a data storage device, the cryptographic system comprising:
means for generating a cryptographic seed value;
means for using a pseudorandom number output associated with the cryptographic seed value to perform one or more cryptographic operations on user data stored by the data storage device; and
means for controlling an integrated hardware cryptography module of the cryptographic system to the generate pseudorandom number output associated with the cryptographic seed value by using:
means for receiving, by the integrated cryptography module, the cryptographic seed value;
means for generating, by one or more hashing components of the integrated cryptography module, hashing data representing a result of performing a hashing operation on the cryptographic seed value;
means for providing the hashing data to one or more auxiliary components of the cryptography module; and
means for generating, by the one or more auxiliary components of the integrated cryptography module, auxiliary data representing a result of performing one or more auxiliary operations on at least the hashing data.
